(19) United States
(12) Patent Application Publication
(10) Pub. No.: US 2012/0196471 A1
(43) Pub. Date: Aug. 2, 2012

(54) Quick Connection Device for Electric Appliance

(76) Inventor: Wenbin Guo, Foshan City (CN)

(21) Appl. No.: 13/389,587

(22) PCT Filed: Aug. 9, 2009
(86) PCT No.: PCT/CN2009/073298

§ 371 Date: Apr. 19, 2012

(51) Int. Cl. H01R 13/627

(52) U.S. Cl. 439/345

(57) ABSTRACT

A quick connection device for electric appliance includes a base (1) and a plug (2), the base (1) has several grooves (11), each groove (11) has a contact (3) connected with electrical wires, the base (1) has a center hole (12), the plug (2) has several conductive rings (4) mated with the grooves (11), the outside of the plug (2) has wiring interface (5) electrically connected with the conductive rings (4), the plug (2) has a connecting rod (6) which is able to be inserted into the center hole (12), the connecting rod (6) has a lock structure (7) fixed to the center hole (12). The electric appliance, such as a fan and a droplight, is fixed to the plug (2), then the plug (2) is fixed to the base (1) by the connecting rod (6), the plug (2) is separated from the base (1) by unlocking the lock structure (7), the device is operated quickly and easily, and it can carry a heavy load.

### FIELD OF THE INVENTION

The present invention relate to a connection device for electric appliance.

### DESCRIPTION OF THE RELATED ART

For the electric appliances used in dailylife, such as droplight, ceiling fan etc., usually they are mounted to the indoor suspended ceiling in a manner of hanging. Since the electric appliances are fixed to the power cord, from which its very difficult to remove once installed, its impossible to clean the electric appliances except wiping them on a ladder, thus its inconvenient and unsafe. It was suggested that using a connection device to connect a electric appliance to the power cord, however, such operation is complicate and, the strength of joint is insufficient to afford a heavy electric appliance.

### SUMMARY OF THE INVENTION

The technical problem to be solved by the present invention is to provide a quick connection device for electric appliance, which is convenient to use and capable of affording heavy weight.

As a solution of above technical problem, a quick connection device for electric appliance according to the present invention comprise a base and a plug. The base has several grooves, each groove has a contact connected with electrical wires, the base has a center hole, the plug has several conductive rings mated with the grooves, the outside of the plug has wiring interface electrically connected with the conductive rings, the plug has a connecting rod which is able to be inserted into the center hole, the connecting rod has a lock structure fixed to the center hole.

As an improvement of above technical solution, a first round gear tooth surface is arranged on the outer side of the base and a second round gear tooth surface mated with the first round gear tooth surface is arranged on the inner side of the plug, wherein the gear teeth of first and second round gear tooth surface are in a same orientation towards the axis.

As a further improvement of the above technical solution, the lock structure comprise a moving rod fitted in the connecting rod. The connecting rod is provided with through holes, in which there is arranging some movable steel balls. The moving rod is provided with grooves mated with the steel balls. A spring is arranged between the moving rod and the connecting rod.

The advantageous effect of the present invention: as the above structure is adopted in this quick connection device for electric appliance, in the case of installing the electric appliance, such as a droplight, a ceiling fan etc., it's mounted to the base by the connecting rod; in the case of disconnecting, the plug and the base could be separated by unlocking the lock structure, the operation is therefore simple and fast, and a big loading capacity is achieved.

### BRIEF DESCRIPTION OF THE DRAWINGS

The following is detailed description to the present invention with reference to the figures and the embodiments.

FIG. 1 is the structural representation of the present invention;

FIG. 2 is the structural representation of the plug;

FIG. 3 is the structural representation of the base;

FIG. 4 is the exploded view of the structure of the present invention.

### DESCRIPTION OF THE EMBODIMENT

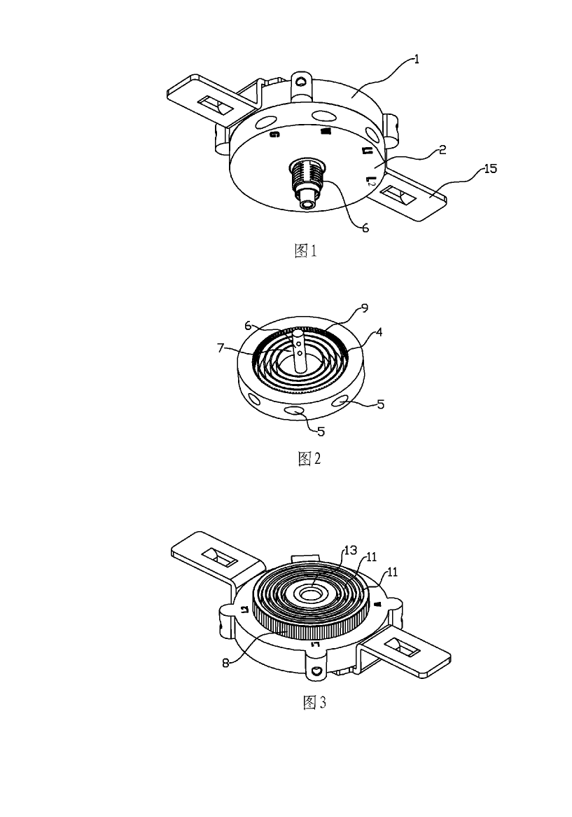

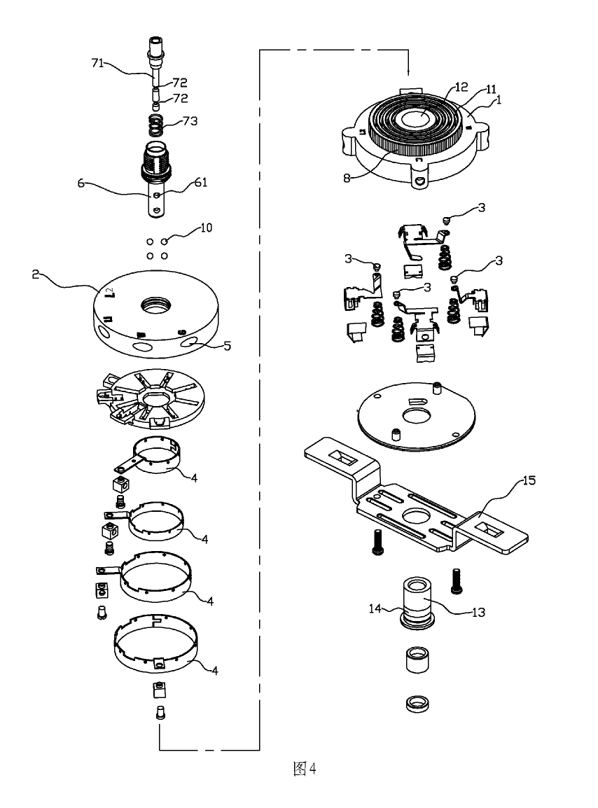

FIG. 1 to FIG. 3 shows a quick connection device for electric appliance of the present invention comprising a base 1 and a plug 2, wherein base 1 has several grooves 11, each of grooves 11 has a contact 3 connected with electrical wires, base 1 has a center hole 12, plug 2 has several conductive rings 4 mated with grooves 11, the outside of the plug has a wiring interface 5 electrically connected with conductive rings 4, plug 2 has a connecting rod 6 which is able to be inserted into center hole 12, connecting rod 6 has a lock structure 7 fixed to center hole 12. As the above structure is adopted in this quick connection device for electric appliance, in the case of installing the electric appliance, such as a droplight, a ceiling fan etc., connecting rod 6 connect with base 1 and be locked and fixed by lock structure 7; in the case of disconnecting, plug 2 and base 1 could be separated by unlocking lock structure 7, the operation is therefore simple and fast, and a big loading capacity could be achieved.

As referred to FIG. 4, a first round gear tooth surface 8 is arranged on the outter side of base 1 and a second round gear tooth surface 9 mated with first round gear tooth surface 8 is arranged on the inner side of plug 2, wherein the gear teeth of first round gear tooth surface 8 and second round gear tooth surface 9 are in a same orientation towards the axis. By adopting above structure, there will be no relative rotation between plug 2 and base 1 after they connect with each other, furthermore, since the gear teeth of first round gear tooth surface 8 and second round gear tooth surface 9 are in a same orientation towards the axis, tiny offset of the position between base 1 and plug 2 under a loading condition will not affect the performance of locking.

Lock structure 7 comprise a moving rod 71 fitted in connecting rod 6. Connecting rod 6 is provided with through holes 61, in which there is arranging movable steel balls 10. Moving rod 71 is provided with grooves 72 mated with the steel balls 10. A spring 73 is arranged between moving rod 71 and connecting rod 6. A metal suite 13 is fitted in center hole 12, wherein the inner side of metal suite 13 is provided with grooves 14 mated with steel balls 10. When connecting the plug with the base, moving rod 71 is pressed down, which make grooves 72 move to the position of steel balls 10, so that steel balls 10 fall into grooves 72 with an offset away from through hole 61 in a sideway direction, connecting rod 6 is then smoothly be inserted into metal suite 13. Releasing moving rod 71 when connecting rod 6 move to a position at which steel balls 10 could fit into grooves 14, so that moving rod 71 push steel balls 10 to move sideway and partially enter grooves 14, which make connecting rod 6 locked into metal suite 13.

In order to increase the strength of joint, a supporting rack 15 is mounted at the rear side of base 1, and the end of metal suite 13 is fixed onto supporting rack 15, which directly transfers the load to supporting rack 15 via connecting rod 6 and metal suite 13 and not affecting either the plug or the base, thus security of usage is guaranteed.

1. A quick connection device for electric appliance comprising a base 1 and a plug, characterized in that the base has grooves, each of which has a contact connected with electrical wires, and a center hole, the plug has conductive rings mated with the grooves, the plug has a wiring interface electrically connected with the conductive rings, and a connecting rod which is able to be inserted into and locked with the center hole through a lock structure fixed to center hole.

2. A quick connection device for electric appliance according to claim 1, characterized in that a first round gear tooth surface is arranged on the outer side of the base and a second round gear tooth surface mated with first round gear tooth surface is arranged on the inner side of the plug, wherein the orientation of the gear teeth of first round gear tooth surface and the orientation of the gear teeth of second round gear tooth surface are both in the axial direction thereof.

3. A quick connection device for electric appliance according to claim 1, characterized in that lock structure comprises a moving rod fitted in the connecting rod which is provided with through holes, wherein movable steel balls are arranged in the through holes, and the moving rod is provided with grooves mated with the steel balls, with a spring arranged between the moving rod and the connecting rod.

4. A quick connection device for electric appliance according to claim 3, characterized in that a metal suite is fitted in center hole, wherein the metal suite is provided with grooves inside thereof mated with the steel balls.

5. A quick connection device for electric appliance according to claim 1, characterized in that a supporting rack is mounted at the rear side of the base, wherein the end of a metal suite is fixed onto the supporting rack.

6. A quick connection device for electric appliance according to claim 2, characterized in that the lock structure comprises a moving rod fitted in the connecting rod which is provided with through holes, wherein movable steel balls are arranged in the through holes, and the moving rod is provided with grooves mated with the steel balls, with a spring arranged between the moving rod and the connecting rod.

7. A quick connection device for electric appliance according to claim 2, characterized in that a metal suite is fitted in the center hole, wherein the metal suite is provided with grooves inside thereof mated with steel balls.

8. A quick connection device for electric appliance according to claim 2, characterized in that a supporting rack is mounted at the rear side of base, wherein the end of a metal suite is fixed onto the supporting rack.
